(19) United States
(12) Patent Application Publication
(10) Pub. No.: US 2014/0249971 A1
(43) Pub. Date: Sep. 4, 2014

(54) ELECTRONIC RECEIPT MANAGEMENT SERVER, INFORMATION PROCESSING DEVICE, AND INFORMATION PROCESSING METHOD

(71) Applicant: TOSHIBA TEC KABUSHIKI KAISHA, Tokyo (JP)

(72) Inventors: Akiko SUSAKI, Tokyo (JP); Shinya TAKAKURA, Shizuoka (JP); Hiroaki IMAI, Osaka (JP); Kunihiro YAMADA, Osaka (JP); Masayoshi NAKATANI, Shizuoka (JP); Takamitsu MUKUNASHI, Aichi (JP); Kou TANAKA, Osaka (JP); Takeshi YOSHIMURA, Kyoto (JP); Naomichi YAMAMOTO, Osaka (JP); Kento DOAMI, Aichi (JP); Jun SUGIYAMA, Shizuoka (JP); Tomoyuki ANAMI, Hyogo (JP); Tsuyoshi GOTANDA, Tokyo (JP)

(73) Assignee: TOSHIBA TEC KABUSHIKI KAISHA, Tokyo (JP)

(21) Appl. No.: 14/194,556

(22) Filed: Feb. 28, 2014

(30) Foreign Application Priority Data
Mar. 1, 2013 (JP) 2013-041291
Jun. 26, 2013 (JP) 2013-134281

(51) Int. Cl. G06Q 40/00

(52) U.S. Cl. CPC G06Q 40/12
USPC 705/30

(57) ABSTRACT

An electronic receipt management server includes an electronic receipt management unit for managing a code of each consumer and electronic receipt information in correlation with each other, a first receiving unit for receiving from an information processing device of a consumer a selection of electronic receipt information that is an object of grouping, among the electronic receipt information correlated with the code, and a first grouping unit for grouping the selected electronic receipt information into a group to be managed by the electronic receipt management unit.

### CROSS-REFERENCE TO RELATED APPLICATION

This application is based upon and claims the benefit of priority from Japanese Patent Application No. 2013-041291, filed Mar. 1, 2013 and Japanese Patent Application No. 2013-134281, filed Jun. 26, 2013 and the entire contents of both applications are incorporated herein by reference.

### FIELD

Embodiments described herein relate generally to an electronic receipt management server, an information processing device, and an information processing method thereof.

### BACKGROUND

In an electronic receipt system of the related art, a receipt given to a consumer who is a shopper at a store is electronically delivered to a mobile terminal or the like of the consumer upon payment for the merchandise.

Less receipt paper may be consumed by replacing paper receipts with electronic data in this manner, which is beneficial to a store in which the electronic receipt system is adopted.

In addition, it is also known that a coupon or the like, which is related to the purchased merchandise, may be electronically attached to the electronic receipt, thereby allowing the selling entity supplying the electronic receipt to perform electronic sales promotion and advertisement of merchandise.

However, the electronic receipt system of the related art is introduced on a per company basis. Therefore, a user of the electronic receipt has to receive a paper receipt in the same manner as before when using a store of a company that has not introduced the electronic receipt system. Therefore, it is desirable to promote the introduction of the electronic receipt. Moreover, a technology which enables the electronic receipt system to be effectively utilized is desired.

### DESCRIPTION OF THE DRAWINGS

FIG. 1 is a configuration diagram illustrating the overall configuration of an electronic receipt system according to an embodiment.

FIG. 2 is a block diagram illustrating the configuration of a mobile terminal.

FIG. 3 is a block diagram illustrating the configuration of a POS terminal.

FIG. 4 is a block diagram illustrating the configuration of an electronic receipt server.

FIG. 5 is a block diagram illustrating the configuration of an electronic receipt management server.

FIG. 6 is a schematic diagram exemplarily illustrating the data configuration of electronic receipt information.

FIG. 7 is a schematic diagram exemplarily illustrating the data configuration of grouping information.

FIG. 8 is a functional block diagram of an electronic receipt processing performed in the POS terminal.

FIG. 9 is a flow chart illustrating the flow of the electronic receipt processing.

FIG. 10 is a flowchart illustrating the flow of information transmission processing performed in the electronic receipt server.

FIG. 11 is a functional block diagram of an electronic receipt management processing and a merchandise information transmission processing performed in the electronic receipt management server.

FIG. 12 is a flow chart illustrating the flow of the electronic receipt management processing and the merchandise information transmission processing.

FIG. 13 is a functional block diagram of an electronic receipt receiving processing and an electronic receipt reading processing performed in a mobile terminal.

FIG. 14 is a flow chart illustrating the flow of the electronic receipt receiving processing and the electronic receipt reading processing.

FIG. 15 is a front view illustrating a display example in the mobile terminal.

FIG. 16 is a front view illustrating a display example in the mobile terminal.

FIG. 17 is a front view illustrating a display example in the mobile terminal.

FIG. 18 is a flow chart illustrating the flow of the electronic receipt receiving processing and the electronic receipt reading processing.

FIG. 19 is a flow chart illustrating the flow of grouping processing performed in the mobile terminal.

FIG. 20 is a front view illustrating a display example in the mobile terminal.

FIG. 21 is a front view illustrating a display example in the mobile terminal.

FIG. 22 is a front view illustrating a display example in the mobile terminal.

FIG. 23 is a flow chart illustrating the flow of comment addition processing performed in the mobile terminal.

FIG. 24 is a front view illustrating a display example in the mobile terminal.

FIG. 25 is a front view illustrating a display example in the mobile terminal.

FIG. 26 is a front view illustrating a display example in the mobile terminal.

### DETAILED DESCRIPTION

Embodiments provide an electronic receipt management system which may promote the introduction and acceptance of electronic receipts and also enhance the effective use of the electronic receipt, an information processing device, and an information processing method.

In general, according to one embodiment, there is provided an electronic receipt management server including an electronic receipt management unit configured to manage a code of each consumer and electronic receipt information in correlation with each other, a first receiving unit configured to receive from an information processing device of a consumer a selection of electronic receipt information that is an object of grouping, among the electronic receipt information correlated with the code, and a first grouping unit configured to group the selected electronic receipt information into a group to be managed by the electronic receipt management unit.

Exemplary embodiments will be described referring to drawings.

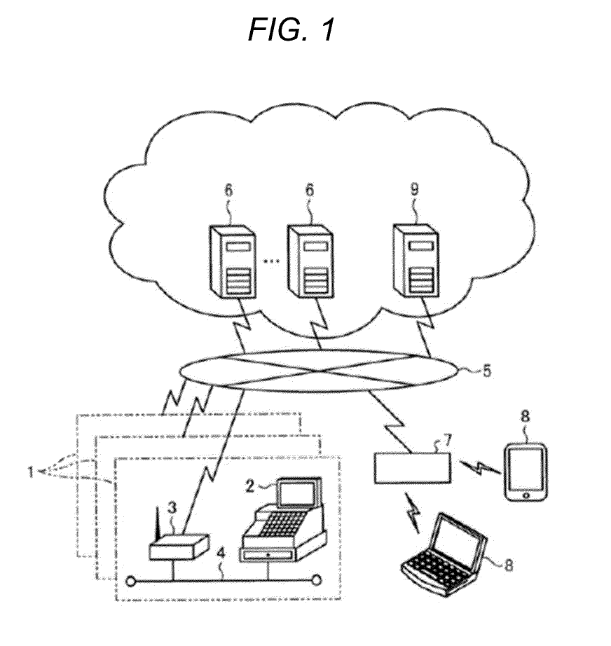

FIG. 1 is a configuration diagram illustrating the overall configuration of an electronic receipt system according to an embodiment. As illustrated in FIG. 1, a Point of Sales (POS) terminal 2, (only one is illustrated in FIG. 1, but this may be several) which is a merchandise sales data processing device capable of executing merchandise sales data processing, and a router 3 are provided in a store 1. The store 1 is a store or a chain store (hereinafter, referred to as store) such as a convenience store, a supermarket, a grocery store, a drugstore, an apparel store, a home electric appliance shop, a department store, a household merchandise store, or a restaurant, for example. The POS terminal 2 and the router 3 are connected using a Local Area Network (LAN) 4 in the store. The router 3 is an apparatus for connecting the LAN 4 in the store with a network 5 which is the internet or a Virtual Private Network (VPN). Although not particularly illustrated, a store server which performs overall control of the POS terminal 2 may be provided in the store 1.

An electronic receipt server 6 is connected to the network 5. A plurality of electronic receipt servers 6 are provided, one for each company which operates a store and is a seller of merchandise or services, and each performs management by functioning as a receipt management server for a company operating a store and stores electronic receipt information according to the company code. The electronic receipt server 6 may also be the head office server of a POS system having a function of sales management, sales analysis, inventory management and the like of each company operating a store.

In addition, a mobile terminal 8 is connected to the network 5 through a base station 7 which performs a wireless communication according to the standard of Wireless Fidelity (Wi-Fi) or the like. The mobile terminal 8 is an information processing device on which a web browser is loaded, such as a smart phone, a mobile phone, a Personal Digital Assistant (PDA), or a tablet computer. Instead of the mobile terminal 8, an information processing device such as a personal computer like a notebook computer may be applied.

Furthermore, an electronic receipt management server 9 manages electronic receipt information of various companies operating a store in a collective manner, is also connected to the network 5. A consumer who is registered as a member, so as to receive services of the electronic receipt, may obtain electronic receipt information from the electronic receipt management server 9 using the mobile terminal 8 through the network 5. For example, the electronic receipt management server 9 may be managed by a third party other than a company managing the electronic receipt information using the electronic receipt server 6. The electronic receipt server 6 may be also managed by the third party. In addition, management by one server may be provided by configuring the electronic receipt management server 9 to also function as the electronic receipt server 6. Moreover, the function of collective managing of the electronic receipt information of each company, which indicates a company operating a store with a plurality of company codes, e.g., services (application) in Software as a Service (SaaS) form which is a type of cloud computing, may be provided.

Registering a consumer as a member for receiving the electronic receipt services is, for example, performed in the following manner. The consumer transmits a blank, i.e., empty, email to a member management server through the network 5 from the mobile terminal 8. The member management server transmits a Uniform Resource Locator (URL) of a page where membership registration can be accomplished to the email address of the blank email. The consumer accesses the URL, which provides a page for entering membership registration information which is displayed on an input screen H of the mobile terminal 8, and the consumer inputs necessary items for membership registration. In the mobile terminal 8, after completion of inputting the necessary items by a consumer, an input confirmation screen I is displayed. Then, after a consumer inputs a confirmation that the registration information is correct, such as by touching the displayed confirmation button, registration of a member is executed on the member management server. Thereafter, the member management server delivers a membership registration completion mail including a membership code and a password to the mobile terminal 8. Accordingly, the membership registration is completed.

In an electronic receipt system with the configuration of FIG. 1, electronic receipt information which includes the payment information generated by performing merchandise sales data processing in the POS terminal 2 of the store 1, is transmitted to the electronic receipt management server 9 through the electronic receipt server 6 on the network 5, and the electronic receipt information is transmitted to the mobile terminal 8 of a member from the electronic receipt management server 9. The member may confirm the contents of the electronic receipt by displaying the electronic receipt information on the display unit of the mobile terminal 8. Moreover, the electronic receipt management server 9 makes the electronic receipt information available on a web. The mobile terminal 8 on which the web browser is located selects a Uniform Resource Locator (URL), and thereby the mobile terminal 8 may download the electronic receipt information put on the web and read the downloaded information using the web browser. Application software for reading the electronic receipt information may be installed in the mobile terminal 8 to perform a reading.

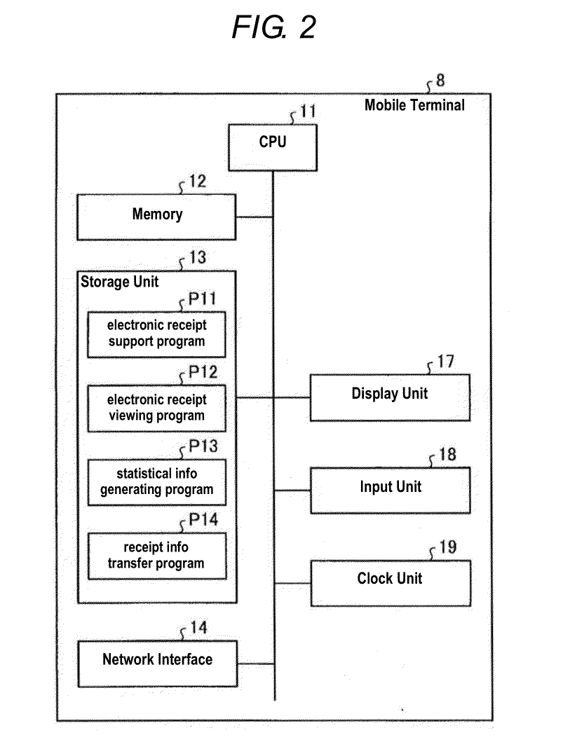

The mobile terminal 8 stores the membership code, and the password obtained by a consumer in the manner described above, in the storage unit 13 or the like (refer to FIG. 2). A method of outputting the membership code stored in this manner includes a display by a bar code, a display by a two-dimensional code, and a transmission by information communication by Near Field Communication (NFC) which is a near-field wireless communication.

Hereinafter, the configuration of each portion which constitutes an electronic receipt system of the embodiment will be described.

First, the configuration of the mobile terminal 8 which is an information processing device will be described using the block diagram of FIG. 2. As illustrated in FIG. 2, the mobile terminal 8 is configured to include a Central Processing Unit (CPU) 11 functioning as the control unit, a memory 12 for temporarily storing data, a storage unit 13 in which reading and writing of data is possible with an instruction from the CPU 11, and programs or data are stored, a network interface 14 connected to various types of public network including the network 5, a display unit 17 which may display various types of information, an input unit 18 for operating the mobile terminal 8, and a clock unit 19 for tracking time. The input unit 18 is a touch panel stacked on the display unit 17, or keys provided on the housing.

In the storage unit 13, in addition to a web browser for reading various types of information (content) disclosed on a web, an electronic receipt correspondence program P11 for receiving electronic receipt information generated, after a consumer payment, by merchandise sales data processing from the electronic receipt management server 9, an electronic receipt reading program P12 for reading the received electronic receipt information, a grouping processing program P12a for grouping the electronic receipt information, and a comment addition processing program P12b for adding comments to the electronic receipt information are pre-installed.

Various types of programs (the electronic receipt correspondence program P11, the electronic receipt reading program P12, the grouping processing program P12a, the comment addition processing program P12b) executed in the mobile terminal 8 are recorded and provided thereto in a computer-readable recording medium such as CD-ROM, flexible disk (FD), CD-R, Digital Versatile Disc (DVD) in a file of an installable format or an executable format.

In addition, the various types of programs to be executed in the mobile terminal 8 may be configured to be provided thereto by being stored on a computer connected to a network such as the internet, and downloaded through a network. In addition, various types of programs to be executed in the mobile terminal 8 may be configured so as to be provided or distributed through a network such as the internet.

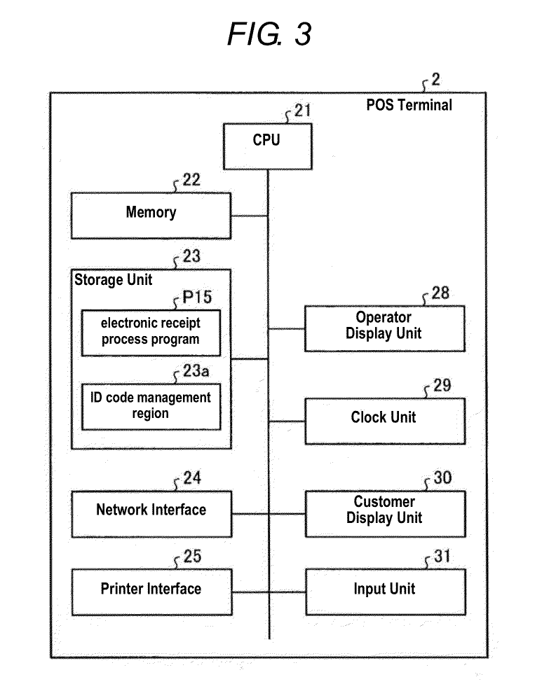

Next, the configuration of a POS terminal 2 which is a merchandise sales data processing device will be described using the block diagram of FIG. 3. As illustrated in FIG. 3, the POS terminal 2 is configured to have a CPU 21 functioning as the control unit, a memory 22 for temporarily storing data, a storage unit 23 in which reading and writing are possible with an instruction thereto from the CPU 21, and in which programs and data are stored, a network interface 24 connected to a LAN 4 in a store, a printer interface 25 to which a printer is connected, a display unit 28 for an operator to display various types of information to an operator, a clock unit 29 for tracking time, a customer display unit 30 for displaying various types of information to a customer, and an input unit 31 for operating the POS terminal 2.

In the storage unit 23, in addition to the POS number of the POS terminal 2, an identification code management region 23a is secured as a region for storing, in advance, a company code (an identification code of a company owning or managing a store), a business type, a business category code, a store code showing the store 1 where the POS terminal 2 is installed, and the like. Here, the business type and the business category code are, for example, codes (sort codes) which sort the business type and the business category of a store into convenience stores, supermarkets, department stores, pharmacies, restaurants and the like. The business type and the business category may be arbitrarily changed according to user's preference. The company code (the identification code of a company owning or managing a store), the business type and the business category code may be registered in the electronic receipt server 6.

Moreover, in the storage unit 23, besides software for executing various types of POS operations including the merchandise sales data processing, an electronic receipt processing program P15 for processing the electronic receipt information, rather than a printed receipt issued during the merchandise sales data process, is pre-installed.

The electronic receipt processing program P15 executed by the POS terminal 2 is recorded and provided thereto in a computer-readable recording medium such as CD-ROM, flexible disk (FD), CD-R, and DVD in a file of an installable format or an executable format.

In addition, the electronic receipt processing program P15 executed by the POS terminal 2 may be configured to be provided thereto by being stored on a computer connected to a network such as the internet and being downloaded through the network. In addition, the electronic receipt processing program P15 executed by the POS terminal 2 may be configured to be provided or distributed thereto through a network such as the internet.

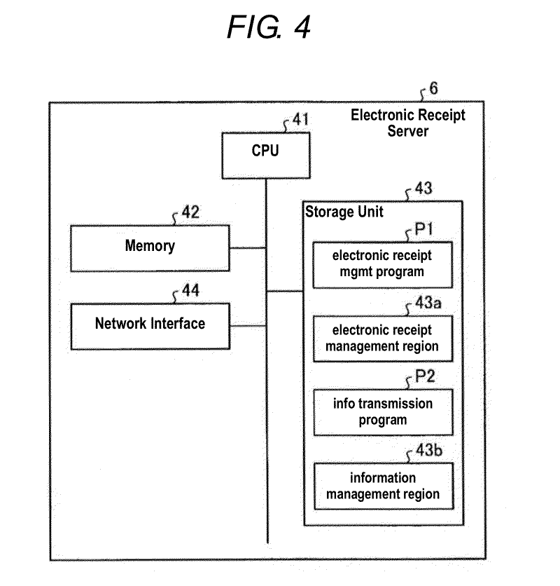

Next, the configuration of the electronic receipt server 6 which functions as the receipt management server for a company will be described using the block diagram of FIG. 4. The electronic receipt server 6 is configured to have a CPU 41 functioning as the control unit, a memory 42 for temporarily storing data, a storage unit 43 in which reading and writing are possible with an instruction from the CPU 41, and programs or data are stored, a network interface 44 connected to the network 5, and the like.

In the storage unit 43, an electronic receipt management region 43a is secured as a region for storing electronic receipt information of each company operating the store 1. The electronic receipt information includes a company code (an identification code of a company owning or managing the store 1), a business type and a business category code, a store code, a membership code of a consumer, a POS number of a POS terminal 2, a receipt number, merchandise sales data, and the like.

In addition, in the storage unit 43, an electronic receipt management program P1 for managing the electronic receipt information received from a POS terminal 2 of each store in the electronic receipt management region 43a is pre-installed.

Moreover, in the storage unit 43, an information transmission program P2 for transmitting the electronic receipt information managed in the electronic receipt management region 43a to the electronic receipt management server 9 is also pre-installed.

Furthermore, in the storage unit 43, an information management region 43b is provided which stores various types of additional information correlated with desired merchandise, a member, a company, or a store. Here, the additional information includes access information such as an URL which is linked to a homepage related to a campaign of a company, an URL which is linked to a homepage related to the commercial of a company, and an URL which is linked to a coupon of a company.

The electronic receipt management program P1 and the information transmission program P2 which are executed by the electronic receipt server 6 are recorded and provided thereto in a computer-readable recording medium such as CD-ROM, flexible disk (FD), CD-R, DVD, and the like in a file of an installable format or an executable format.

Additionally, the electronic receipt management program P1 and the information transmission program P2 which are executed by the electronic receipt server 6 may be configured to be provided thereto by being stored on a computer connected to a network such as the internet and being downloaded through the network. Moreover, the electronic receipt management program P1 and the information transmission program P2 which are executed by the electronic receipt server 6 may be configured to be provided or distributed thereto through a network such as the internet.

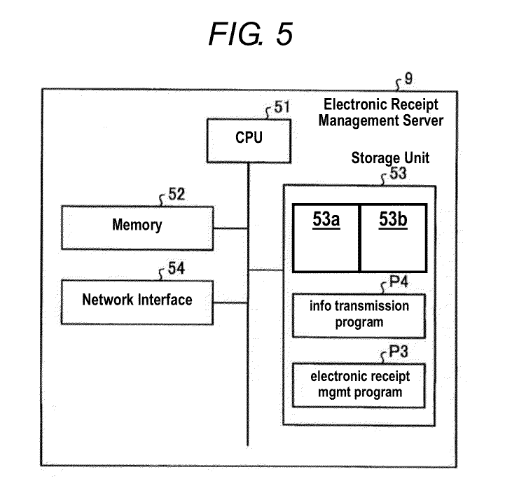

Next, the configuration of the electronic receipt management server 9, which functions as a receipt management server for a customer, will be described using the block diagram of FIG. 5. The electronic receipt management server 9 is configured to include a CPU 51 functioning as the control unit, a memory 52 for temporarily storing data, a storage unit 53 in which reading and writing are possible with an instruction from the CPU 51, and programs or data are stored, a network interface 54 connected to the network 5, and the like.

In the storage unit 53, an electronic receipt management region 53a is secured as a region for collective storing electronic receipt information of various types of companies operating the store 1. In more detail, the electronic receipt management region 53a manages the electronic receipt information and additional information of various types of companies operating a store for every member. The electronic receipt information includes a membership code, a company code (an identification code of a company operating the store 1), a store code, a POS number of the POS terminal 2, a receipt number, merchandise sales data, additional information, and the like.

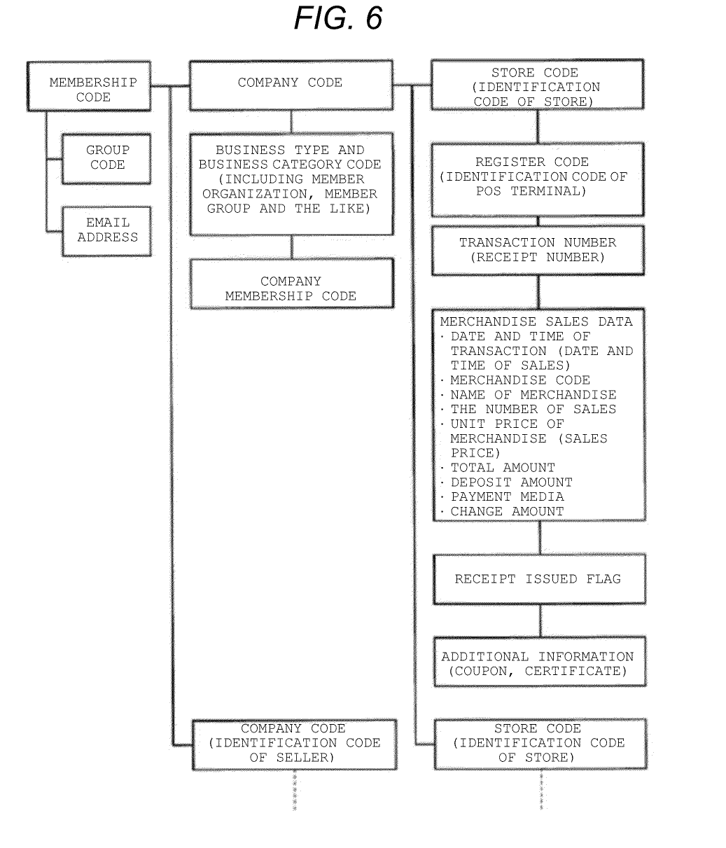

Here, the data configuration of the electronic receipt information stored in the electronic receipt management region 53a will be described. FIG. 6 is a schematic diagram which illustrates the data configuration of electronic receipt information. As illustrated in FIG. 6, the electronic receipt information includes, in correlation with a membership code which is uniquely established for every consumer, a company code (an identification code of a company operating a store), a business type and business category code (in addition to the business type and the business category, a member organization or a member group may be included), a company membership code of a company member card, and the like.

In addition, as illustrated in FIG. 6, the electronic receipt information includes, in correlation with the membership code, a store code (an identification code of a store), a register code (an identification code of the POS terminal 2), a transaction number (receipt number), merchandise sales data, additional information (coupon, certificate, and the like), and the like.

As illustrated in FIG. 6, the merchandise sales data have a transaction date and time (sales date and time), a merchandise code, a merchandise name, a sales number, and a unit price of merchandise (sales price) on an item basis, and also include a total amount, a deposit amount, a payment media, a change amount, and the like.

The electronic receipt information illustrated in FIG. 6 includes the additional information (coupon, certificate, and the like), but is not limited thereto. The electronic receipt information and the additional information (coupon, certificate, and the like) may be managed separately from each other.

Furthermore, as illustrated in FIG. 6, the electronic receipt information includes an email address and a group code related to the membership code. The email address is used in the transmission of an electronic receipt update notification to be described later, or the electronic receipt information. The group code is a code of a predefined group, such as a family or friends.

In addition, in the storage unit 53, an electronic receipt management program P3 for managing the additional information received from the electronic receipt server 6 of each company and the electronic receipt information in the electronic receipt management region 53a is installed in advance.

Moreover, in the storage unit 53, a grouping management region 53b is secured as a region for storing information (grouping information) related to merchandise which is grouped (grouping). More specifically, the grouping management region 53b manages each grouping by a predetermined criterion, electronic receipt information belonging to the group, or merchandise sales data included in the electronic receipt information for every member.

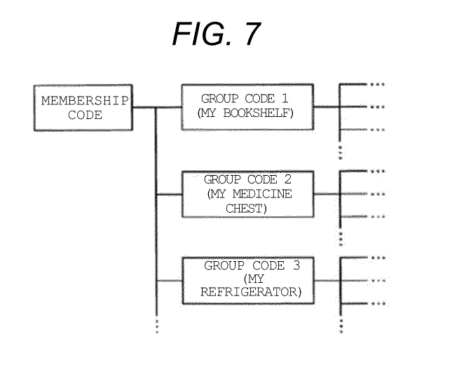

Here, a data configuration of grouping information stored in the grouping management region 53b will be described. FIG. 7 is a schematic diagram which is an exemplary illustration of the data configuration of grouping information. As illustrated in FIG. 7, the grouping information includes a group code (group name), and the like correlated with a membership code. In addition, the grouping information includes electronic receipt information (receipt number) of members belonging to the group, a merchandise code included in the electronic receipt information, all in correlation with a group code.

FIG. 7 illustrates “my bookshelf”, “my medicine chest”, and “my refrigerator” as a group codes. For example, “my bookshelf” is correlated with one or more items of electronic receipt information issued by a book store, or a merchandise code (book code and the like) of a book included in the electronic receipt information. In addition, “my medicine chest”, for example, is correlated with one or more items of electronic receipt information issued by a drugstore or a merchandise code of a medicine included in the electronic receipt information. Moreover, “my refrigerator”, for example, is correlated with one or more items of electronic receipt information issued by a supermarket, or a merchandise code of an item of food included in the electronic receipt information.

In addition, in the storage unit 53, an information transmission program P4 for transmitting the electronic receipt information, additional information of desired merchandise, and the like to the mobile terminal 8 is pre-installed.

The electronic receipt management program P3 and the information transmission program P4 which are executed by the electronic receipt management server 9 are recorded and provided thereto in a computer-readable recording medium such as CD-ROM, flexible disk (FD), CD-R, DVD, in a file of an installable format or an executable format.

In addition, the electronic receipt management program P3 and the information transmission program P4 which are executed by the electronic receipt management server 9 may be configured to be provided thereto by being stored on a computer connected to a network such as the internet and loaded through the network. In addition, an electronic receipt management program P3 and an information transmission program P4 which are executed by the electronic receipt management server 9 may be configured so as to be provided or distributed thereto through a network such as the internet.

Subsequently, the operation of each portion which constitutes the system of the embodiment will be described.

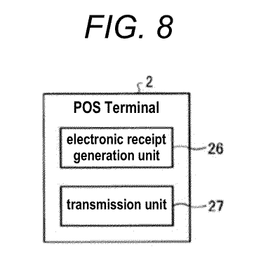

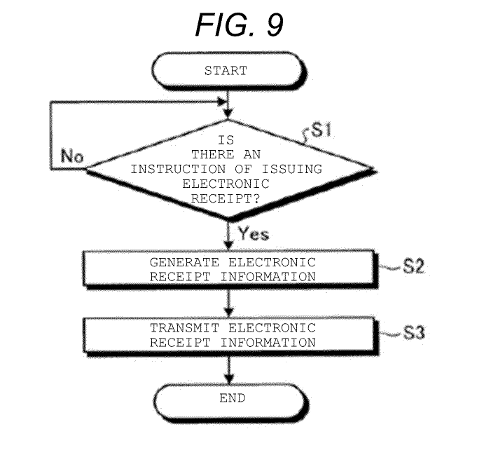

Electronic receipt processing executed by the operation of the CPU 21 of the POS terminal 2 according to the electronic receipt processing program P15 will be described referring to a functional block view illustrated in FIG. 8 and a flow chart illustrated in FIG. 9.

As illustrated in FIG. 8, the electronic receipt processing program P15 which is executed in the POS terminal 2 has a module configuration in which an electronic receipt generation unit 26 functioning as an electronic receipt generation means, and a transmission unit 27 functioning as a transmission means are included. In the hardware, the CPU 21 reads and executes the electronic receipt processing program P15 from the storage unit 23, and thereby each portion thereof described above is loaded on the memory 22 to have the electronic receipt generation unit 26 and the transmission unit 27 generated on the memory 22.

The electronic receipt generation unit 26 generates electronic receipt information, which includes a company code showing a company operating the store 1, and is electronically processed instead of being printed, and issued during the merchandise sales data processing, in correlation with the membership code of a consumer.

The transmission unit 27 transmits electronic receipt information generated by the electronic receipt generation unit 26 to the electronic receipt server 6 which performs management on a per company basis using the company codes.

As illustrated in FIG. 9, when there is an input of an operation of a settlement key to start the settlement processing of a merchandise transaction, the CPU 21 (electronic receipt generation unit 26) of the POS terminal 2 determines whether there is an input of membership code, confirms whether the electronic receipt is issued, and determines whether there is an instruction to issue an electronic receipt correlated with payment processing according to the settlement operation (step S1).

In order for a member to show an instruction for issuing the electronic receipt, for example, a method illustrated below is considered.

1. A clerk operates the “electronic receipt issue” button provided in the input unit 31 (for example, keyboard) of the POS terminal 2.

2. A consumer who is a member has a bar code including a code displayed on the display unit 17 of the mobile terminal 8, and the clerk reads the bar code using the input unit 31 (for example, bar code scanner) of the POS terminal 2.

3. The consumer who is a member operates the “electronic receipt issue” button which is displayed to be pressable on the customer display unit 30.

4. The consumer who is a member has a bar code including a code displayed on the display unit 17 of the mobile terminal 8, and the consumer who is a member scans the bar code using the input unit 31 (for example, a bar code scanner (a scanner different from a scanner used in registering merchandise is preferable)) of the POS terminal 2.

5. When the consumer who is a member presents a company member card for receiving a point service (loyalty program card or number), reads a company membership code of the company member card using the input unit 31 of the POS terminal 2 (for example, a bar code scanner, a magnetic card reader, or NFC), and the membership code of the electronic receipt is associated with the read company membership code, it is determined that there is an instruction to issue an electronic receipt.

The CPU 21 (electronic receipt generation unit 26) of the POS terminal 2, when determining there is an instruction to issue an electronic receipt (Yes in step S1), transmits merchandise transaction data to a head office server, and extracts a company code (an identification code of a company owning or managing a store), a business type and a business category code, a store code, a membership code of a consumer, a POS number of the POS terminal 2, a receipt number, merchandise sales data, and the like from the identification code management region 23a provided in the storage unit 23 to generate an electronic receipt based on the merchandise information and payment information which are registered during a payment by the merchandise sales data processing (step S2).

Next, the CPU 21 (transmission unit 27) of the POS terminal 2 connects to the LAN 4 and the network 5 in the store through the network interface 24, and transmits the generated electronic receipt information (electronic receipt) to the electronic receipt server 6 (step S3) to complete the processing. When determining whether there is no instruction to issue an electronic receipt, the CPU 21 prints and issues a paper receipt and transmits the merchandise transaction data to the head office server to complete the processing.

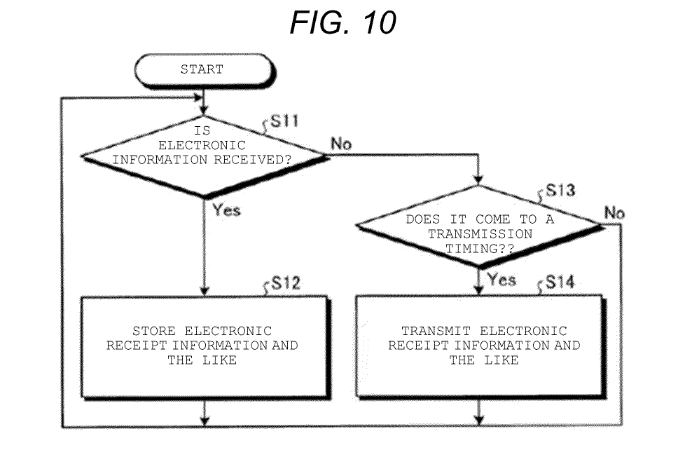

Next, the flow of electronic receipt management processing executed by the operation of the CPU 41 of the electronic receipt server 6 according to the electronic receipt management program P1, and information transmission processing executed by the operation of the CPU 41 according to the information transmission program P2 will be described referring to the flow chart illustrated in FIG. 10.

When the CPU 41 of the electronic receipt server 6 receives the electronic receipt information transmitted from the POS terminal 2 through the network interface 44 (Yes in step S11), the electronic receipt information is stored as electronic receipt information in the electronic receipt management region 43a of the storage unit 43 (step S12). That is, the CPU 41 of the electronic receipt server 6 manages the electronic receipt information using the storage unit 43 on a per company basis according to a company code.

Additionally, the CPU 41 of the electronic receipt server 6 stores the received electronic receipt information, and then when it comes to a transmission, for which timing is set in advance (No in step S11, Yes in step S13), it transmits the additional information managed in the information management region 43b and the electronic receipt information managed in the electronic receipt management region 43a to the electronic receipt management server 9 (step S14), and thereby the procedure returns to step S11.

The CPU 21 of the POS terminal 2 (electronic receipt generation unit 26) generates electronic receipt information to be transmitted to the electronic receipt server 6, but is not limited thereto. For example, the CPU 21 of the POS terminal 2 may transmit a store code, the membership code of a consumer, a POS number of the POS terminal 2, a receipt number, merchandise sales data, and the like to the electronic receipt server 6 based on information of merchandise and the payment information registered during a payment by merchandise sales data processing, and the CPU 41 of the electronic receipt server 6 may add a company code, a business type and a business category code, and the like to generate the electronic receipt information.

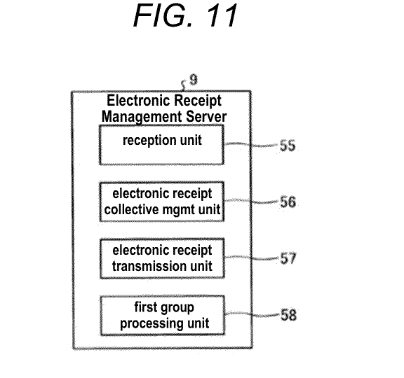

Next, a functional configuration which is realized by the operation of the CPU 51 of the electronic receipt management server 9 according to the electronic receipt management program P3 and the information transmission program P4 will be described referring to functional blocks illustrated in FIG. 11.

As illustrated in FIG. 11, the electronic receipt management program P3 and the information transmission program P4 which are executed by the electronic receipt management server 9 have a module configuration in which there are a receiving unit 55 functioning as a receiving means, an electronic receipt collective management unit 56 functioning as an electronic receipt management means, an electronic receipt transmission unit 57 functioning as an electronic receipt transmission means, and a first grouping processing unit 58 functioning as a first receiving means, a second receiving means and a first grouping means. As actual hardware, the CPU 51 reads the electronic receipt management program P3 and the information transmission program P4 from a storage unit 53 to execute both of the programs, and thereby each portion described above is loaded on the memory 52, and the receiving unit 55, the electronic receipt collective management unit 56, the electronic receipt transmission unit 57, and the first grouping processing unit 58 are generated on the memory 52.

The receiving unit 55 receives electronic receipt information on a per company basis which includes a company code showing a company operating the store 1 and is electronically processed instead of being printed, and issued during merchandise sales data processing. Moreover, the receiving unit 55 receives various types of information transmitted from the mobile terminal 8.

The electronic receipt collective management unit 56 stores the electronic receipt information received by the receiving unit 55 in the electronic receipt management region 53a of the storage unit 53 to be collectively managed. In addition, the electronic receipt collective management unit 56 stores grouping information for grouping the electronic receipt information and merchandise sales data in the grouping management region 53b to be managed.

The electronic receipt transmission unit 57 obtains the electronic receipt information including one or more company codes correlated with the membership code from the electronic receipt management region 53a to be transmitted to the mobile terminal 8 correlated with the membership code of a predetermined consumer.

The first grouping processing unit 58 receives grouping information which indicates the electronic receipt information which is an object of grouping among the electronic receipt information correlated with the membership code, from the mobile terminal 8 correlated with the membership code of each consumer. Then, the first grouping processing unit 58 correlates received grouping information with the membership code of the mobile terminal 8 to be maintained in the grouping management region 53b of the electronic receipt collective management unit 56, so that the grouping information is managed in the grouping management region 53b.

In addition, the first grouping processing unit 58 receives a designation of group from the mobile terminal 8 correlated with the membership code of each consumer. Then, the first grouping processing unit 58 cooperates with the electronic receipt transmission unit 57 to transmit electronic receipt information belonging to a designated group among electronic receipt information correlated with the membership code of the mobile terminal 8 to the mobile terminal 8.

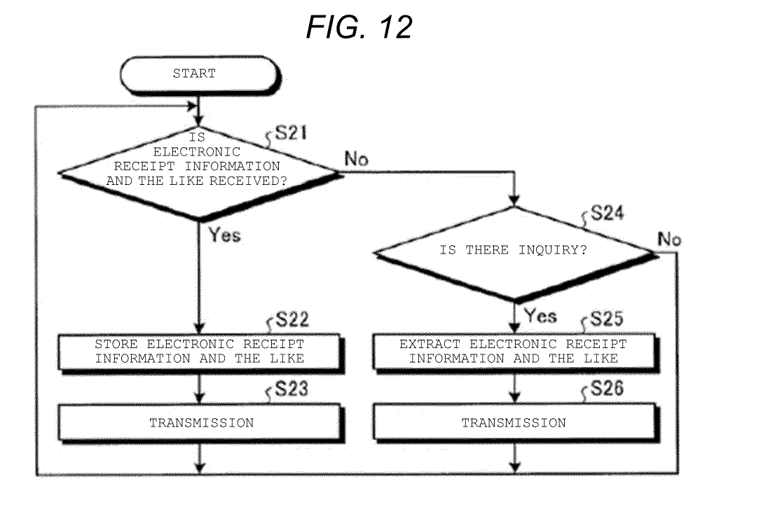

Here, the flow of electronic receipt management processing which is executed by an operation according to the electronic receipt management program P3 described above, and merchandise information transmission processing which is executed by the operation according to the information transmission program P4 will be described referring to a flow chart illustrated in FIG. 12.

As illustrated in FIG. 12, the CPU 51 of the electronic receipt management server 9 (the receiving unit 55) determines whether or not the electronic receipt information and the additional information transmitted from the electronic receipt server 6 of each company through the network interface 54 have been received (step S21).

When receiving the electronic receipt information and the additional information (Yes in step S21), the CPU 51 (the electronic receipt collective management unit 56) of the electronic receipt management server 9 collectively-stores the electronic receipt information and the additional information of various types of companies in the electronic receipt management region 53a of the storage unit 53 (step S22).

Moreover, the CPU 51 of the electronic receipt management server 9 (the electronic receipt transmission unit 57) collectively-stores the electronic receipt information and the additional information in the electronic receipt management region 53a, and then transmits the electronic receipt information and the additional information to the mobile terminal 8 (step S23), and thereby the procedure returns to step S21. When the transmission of the electronic receipt information is completed, a flag indicating completion of the transmission of the electronic receipt information of the electronic receipt management region 53a is stored, and thereby it is possible to track a transmission result of the electronic receipt information.

Moreover, the CPU 51 of the electronic receipt management server 9 (the electronic receipt transmission unit 57), when there is an electronic receipt information inquiry from the mobile terminal 8 (No in step S21, Yes in step S24), extracts the additional information and the electronic receipt information managed in the electronic receipt management region 53a according to the content of the electronic receipt information inquiry (step S25) to be transmitted to the mobile terminal 8 where there is the inquiry (step S26), and thereby the procedure returns to step S21.

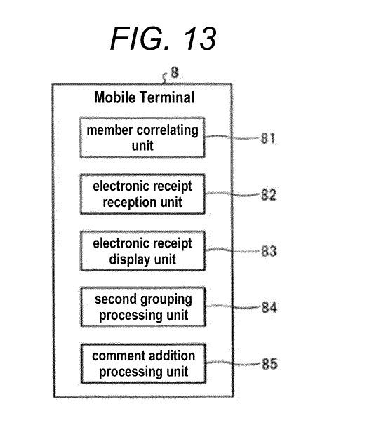

Next, a functional configuration which is executed by the operation of the CPU 11 of the mobile terminal 8 according to the electronic receipt correspondence program P11, the electronic receipt reading program P12, the grouping processing program P12a and the comment addition processing program P12b will be described referring to functional blocks illustrated in FIG. 13.

As illustrated in FIG. 13, the electronic receipt correspondence program P11, the electronic receipt reading program P12, the grouping processing program P12a, and the comment addition processing program P12b which are executed in the mobile terminal 8 are modularly configured to include a member correlating unit 81 functioning as member correlating means, an electronic receipt receiving unit 82 functioning as an electronic receipt receiving means, an electronic receipt display unit 83 functioning as an electronic receipt display means, a second grouping processing unit 84 functioning as a third receiving means, a fourth receiving means, and a second grouping means, and a comment addition processing unit 85. As actual hardware, the CPU 11 reads the electronic receipt correspondence program P11, the electronic receipt reading program P12, the grouping processing program P12a, and the comment addition processing program P12b from the storage unit 13 to be executed, and thereby each portion described above is loaded on the memory 12, and a member correlating unit 81, an electronic receipt receiving unit 82, an electronic receipt display unit 83, a second grouping processing unit 84, and a comment addition processing unit 85 are generated on the memory 12.

The member correlating unit 81 correlates the membership code of a predetermined consumer.

The electronic receipt receiving unit 82 receives electronic receipt information which is correlated with the membership code and includes one or more company codes from an electronic receipt management server 9 which collectively manages the electronic receipt information.

The electronic receipt display unit 83 arranges the electronic receipt information received by the electronic receipt receiving unit 82 on a per company code basis to be displayed on the display unit 17.

The second grouping processing unit 84 executes grouping processing to be described later so as to group the electronic receipt information or merchandise sales data included in the electronic receipt in one group. Moreover, the second grouping processing unit 84 provides various types of user interfaces so as to display a result of the grouping.

The comment addition processing unit 85 executes comment addition processing to be described later so as to add comments to the electronic receipt information or the merchandise sales data (merchandise code) included in the electronic receipt. Moreover, the comment addition processing unit 85 provides various types of user interfaces in order to display added comments.

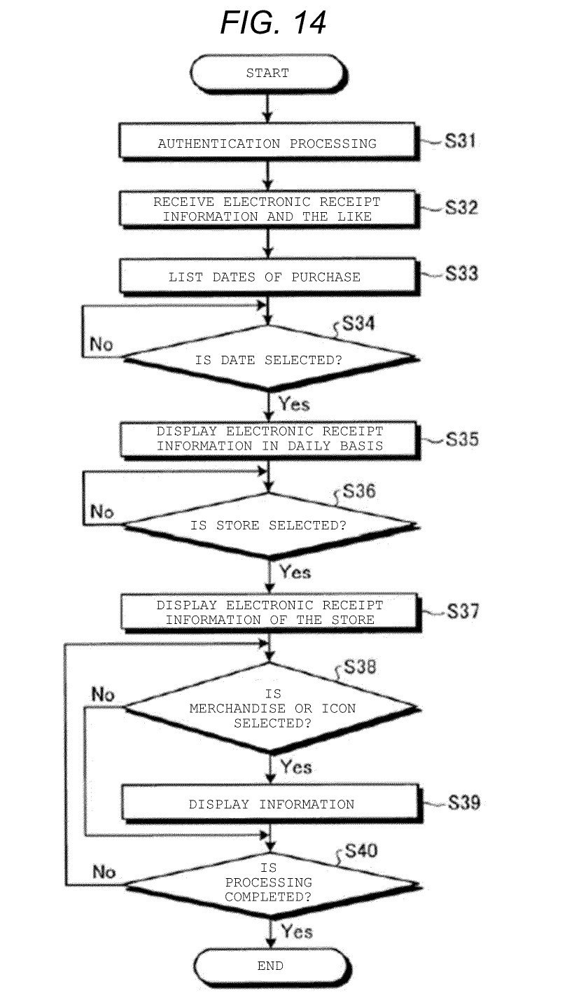

Here, the flow of the electronic receipt receiving processing which is executed by the operation according to the electronic receipt correspondence program P11 and the electronic receipt reading processing which is executed by the operation according to the electronic receipt reading program P12 will be described referring to a flow chart illustrated in FIG. 14.

As illustrated in FIG. 14, first, the CPU 11 (the member correlating unit 81) of the mobile terminal 8 accesses the electronic receipt management server 9, and executes authentication processing by the input of membership code and password (step S31). Accordingly, the mobile terminal 8 and the membership code of a predetermined consumer are correlated with each other.

After the authentication, the CPU 11 (the electronic receipt receiving unit 82) of the mobile terminal 8 receives the additional information and the electronic receipt information which correspond to the input membership code and are managed in the electronic receipt management region 53a (step S32). The reception of the additional information and the electronic receipt information may be performed by e-mail.

Next, the CPU 11 of the mobile terminal 8 (the electronic receipt display unit 83) lists the dates of purchase included in the electronic receipt information on the display unit 17 (step S33). By listing the dates of purchase on the display unit 17, the mobile terminal 8 prompts a user who is a consumer to select information.

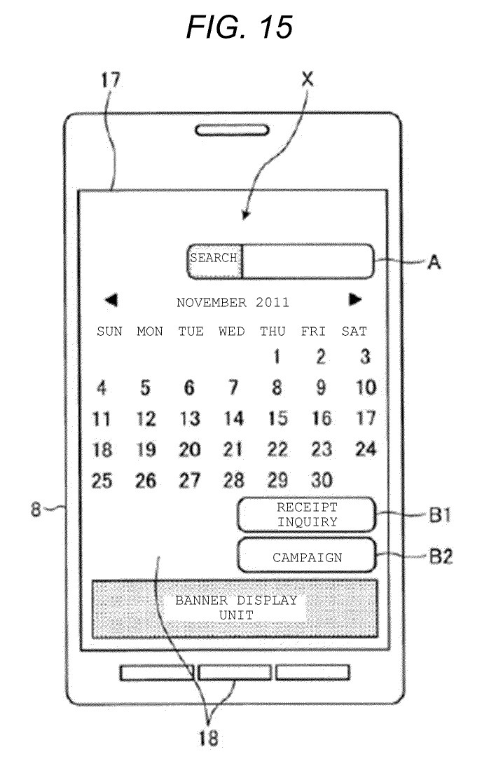

FIG. 15 is a front view which illustrates a display example X on the display unit 17 of the mobile terminal 8. As illustrated in FIG. 15, the display example X is a list in which the dates of purchase in the store 1 of various types of companies by a user who has the mobile terminal 8 accessing the electronic receipt management server 9 are changed in color and are shown in a calendar format. In addition, the CPU 11 (the electronic receipt display unit 83) of the mobile terminal 8 performs a display so that a desired date may be selected using a cursor following the input of the input unit 18 from among the dates having a different color.

As illustrated in FIG. 15, in the display example X, a search window A for entering the search term and a key word is provided. The CPU 11 of the mobile terminal 8 may narrow down the electronic receipt information based on the search term and the key word entered in the search window A.

Moreover, in the display example X, as illustrated in FIG. 15, there is a “receipt inquiry” button B1 for making a confirmation after selecting a desired date using a cursor. The CPU 11 of the mobile terminal 8 may determine that a user selects a desired date just when the user taps the desired date, and the CPU 11 may determine that a user selects a desired date when the user operates the “receipt inquiry” button B1 after tapping the desired date.

When it is determined that the user selects a desired date by tapping the desired date (Yes in step S34), the CPU 11 of the mobile terminal 8 (the electronic receipt display unit 83), displays on the display unit 17 electronic receipt information corresponding to the selected date.

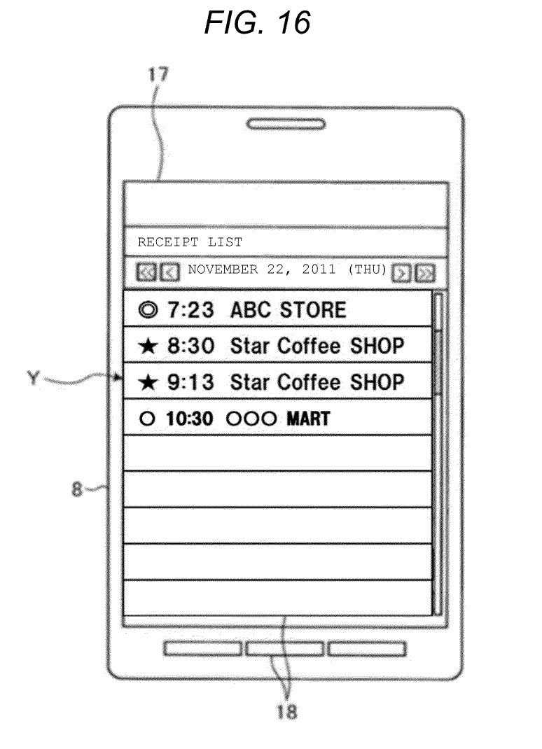

FIG. 16 is a front view illustrating a display example Y in the mobile terminal 8. As illustrated in FIG. 16, the display example Y is a list which lists stores of various types of companies, where a user who has the mobile terminal 8 accessing the electronic receipt management server 9 has purchased merchandise. More specifically, the display example Y is a list in which the stores are displayed in time series in an order of receipt, by the mobile terminal of an electronic receipt, and a company mark or symbol such as the star symbol to the left of “Star Coffee Shop”, a transaction time, a company name, and a store name are displayed. In addition, the CPU 11 of the mobile terminal 8 (the electronic receipt display unit 83) performs a display so as to select a store on a desired date using a cursor following an input of the input unit 18 from the listed store information.

When it is determined that a user selects a store on the desired date, the CPU 11 of the mobile terminal 8 (the electronic receipt display unit 83) (Yes in step S36), displays electronic receipt information corresponding to the selected store on the display unit 17 (step S37).

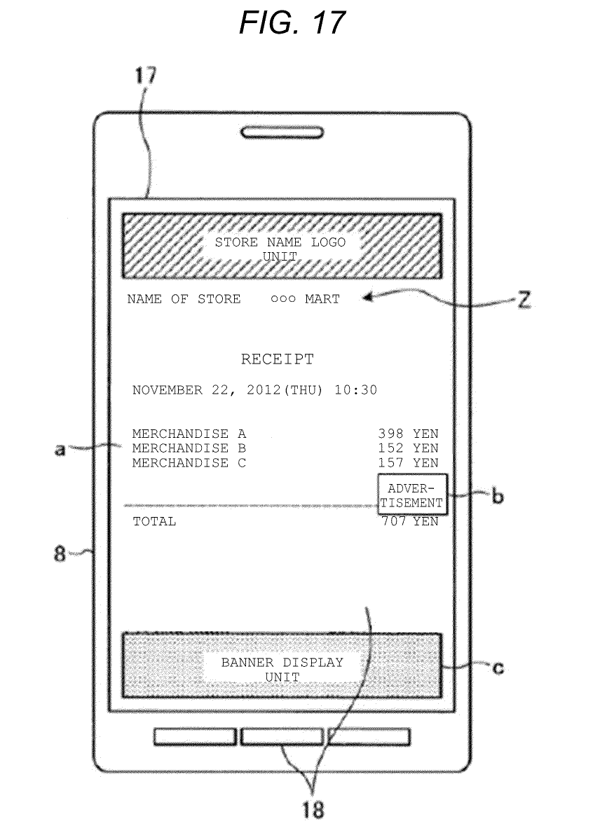

FIG. 17 is a front view of the display unit of the mobile terminal 8 illustrating a display example Z. As illustrated in FIG. 17, the display example Z is the electronic receipt information of the selected store on the desired date. In the display example Z, electronic receipt information is analyzed and presented in a layout that is the same as a paper receipt and it is possible to select displayed items, such as merchandise A, using a cursor followed by the selection of the input unit 18.

A screen display image does not have to be a receipt image. However, the electronic receipt information is a replacement for paper receipt information, and is electronic merchandise purchase authentication information which authenticates a purchase of the merchandise shown in the electronic receipt. In the display example Z, when there is a return, the electronic receipt information is used as the merchandise purchase authentication information presented to a store, such that the following information is displayed.

Name of store

Date and time of purchase

Specification of purchased merchandise

Sales total amount

Deposit amount

Change amount

Register number

Transaction number

Here, when the user selects suitable merchandise or an icon b correlated with the merchandise (Yes in step S38), the CPU 11 (electronic receipt display unit 83) of the mobile terminal 8 accesses the network 5 through the network interface 14, and obtains various types of information via the network 5 based on access information associated with the selected merchandise a or the icon b and displays the information on the display unit 17 (step S39).

For example, when a homepage associated with merchandise as a way of accessing information about merchandise is set as a merchandise information link, and desired merchandise is selected, a homepage associated with the merchandise is displayed on the display unit 17.

Moreover, when a homepage associated with the advertisement information is set as access information to the banner c which is a type of an icon, and the banner c is selected, the advertisement information related to the banner c is displayed on the display unit 17.

The CPU 11 of the mobile terminal 8, when the end of the electronic receipt reading processing is announced from the input unit 18 (Yes in step S40), ends the processing.

The CPU 11 of the mobile terminal 8, when the end of the electronic receipt reading processing is not announced from the input unit 18 (No in step S40), returns the procedure to step S38 and waits for the selection of the merchandise a or the icon b correlated with the merchandise a.

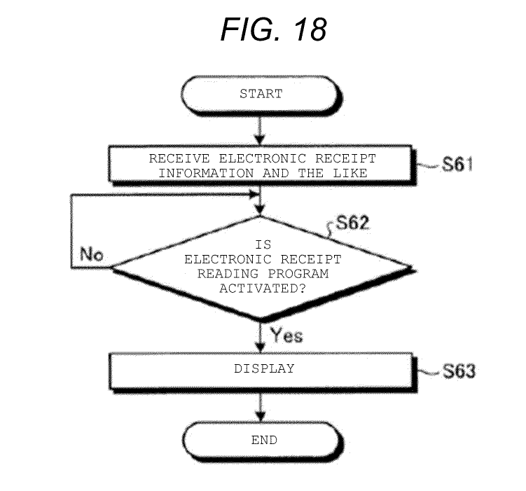

In addition, as described in a step S23 of FIG. 12 described above, a case where the mobile terminal 8 does not access the electronic receipt management server 9 but receives the electronic receipt information and the additional information from the electronic receipt management server 9 will be described referring to the flow chart of FIG. 18.

The CPU 11 (the electronic receipt receiving unit 82) of the mobile terminal 8 receives the electronic receipt information and the additional information from the electronic receipt management server 9 (step S61).

Thereafter, when the electronic receipt reading program P12 is activated (Yes in step S62), the CPU 11 of the mobile terminal 8 (the electronic receipt display unit 83) displays the received electronic receipt information and the received additional information in association with the company code (step S63).

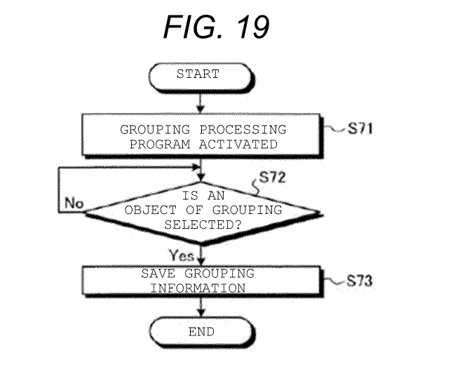

Next, the flow of the grouping processing executed by the operation of the CPU 11 of the mobile terminal 8 according to the grouping processing program P12a will be described referring to the flow chart illustrated in FIG. 19. The processing is executed as a portion of the electronic receipt reading processing described above. In addition, as a premise of this processing, the electronic receipt information illustrated in FIG. 16 is displayed on the display unit 17.

As illustrated in FIG. 19, when the grouping processing program P12a is activated (step S71), the CPU 11 (the second grouping processing unit 84) of the mobile terminal 8 waits until an object of grouping is selected (No in step S72). When the CPU 11 (the second grouping processing unit 84) of the mobile terminal 8 receives the selection of an object of grouping (Yes in step S72), grouping information including a group code is generated and the object of grouping is correlated with the group code. Then, the CPU 11 (the second grouping processing unit 84) of the mobile terminal 8 transmits both the grouping information and the membership code to the electronic receipt management server 9 to be saved, thereby grouping the grouping information and the membership code into the same group to be managed by the electronic receipt management server 9 (step S73).

The CPU 51 (first grouping means) of the electronic receipt management server 9, when receiving the grouping information and the membership code from the mobile terminal 8, stores the grouping information correlated with the membership code in the grouping management region 53b. Accordingly, the CPU 51 (the first grouping means) of the electronic receipt management server 9 groups an electronic receipt selected as an object of grouping into the same group to be managed in the grouping management region 53b. The grouping information stored in the grouping management region 53b may be referred to from the mobile terminal 8.

Here, without particular limitation, electronic receipt information that a user desires or merchandise sales data included in the electronic receipt information may be selected as an object of grouping. For example, grouping may be performed by selecting merchandise sales data for a book from the electronic receipt information as an object of grouping and giving the name of “my bookshelf” and the like as a group code. In addition, grouping may be performed by selecting purchase data of merchandise purchased in a drugstore from the electronic receipt information based on a company code and giving the name of “my medicine chest” and the like as a group code. When selecting merchandise sales data of each item of merchandise, for example, as the display example Z illustrated in FIG. 17, specific merchandise may be selected as an object of grouping from a screen displaying merchandise (merchandise a) included in the electronic receipt information.

Moreover, grouping may be also performed by selecting one or more pieces of information in electronic receipts issued by a supermarket as an object of grouping, and giving the name of “my refrigerator” and the like. In addition, grouping may be performed by selecting one or more items of information in electronic receipts issued by an interiors shop as an object of grouping and giving the name of “my room” and the like. Moreover, grouping may be also performed by selecting one or more items of information in electronic receipts issued by an apparel sales store and giving the name of “my closet” and the like, and grouping may be also performed by selecting one or more items of information in an electronic receipt issued by a restaurant and giving the name of “my food” and the like.

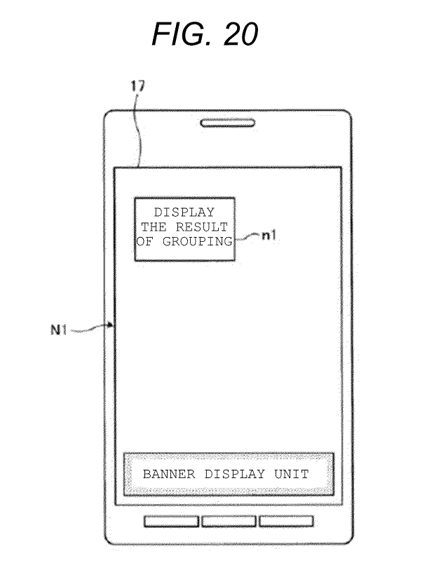

When displaying grouping information stored in the grouping management region 53b of the electronic receipt management server 9, the CPU 11 (the second grouping processing unit 84) of the mobile terminal 8, for example, may provide a user with the user interface as illustrated in FIGS. 20 to 22. FIGS. 20 to 22 are front views illustrating a display example on the display unit 17 of the mobile terminal 8.

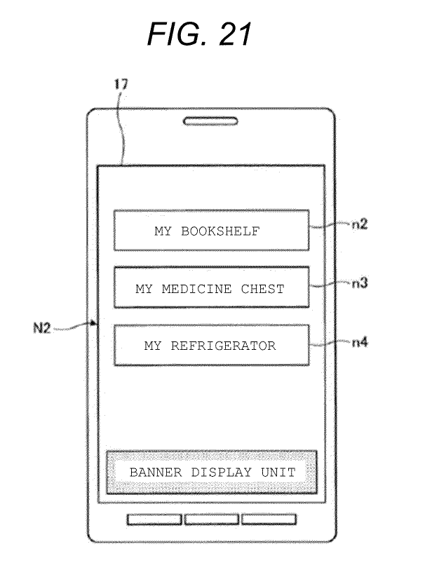

In a display of the grouping results, the CPU 11 (the second grouping processing unit 84) of the mobile terminal 8 displays a button n1, which instructs the device to display the grouping results, on the display unit 17 like the display example N1 illustrated in FIG. 20. The CPU 11 (the second grouping processing unit 84) of the mobile terminal 8, when detecting the selection of the button n1, accesses the electronic receipt management server 9 and refers to (obtains) a grouping code correlated with the membership code of the device from the grouping management region 53b. Then, the CPU (the second grouping processing unit 84) of the mobile terminal 8, like the display example N2 illustrated in FIG. 21, displays a selection screen for selecting each group code on the display unit 17. FIG. 21 displays an example in which my bookshelf n2, my medicine chest n3, and my refrigerator n4 are illustrated as groups.

On the selection screen in FIG. 21, each group of my bookshelf n2, my medicine chest n3 and my refrigerator n4 is configured to be selectable. The CPU 11 (the second grouping processing unit 84) of the mobile terminal 8, when receiving a selection (designation) of any one group, transmits both a designated group code and the membership code of the mobile terminal 8 to the electronic receipt management server 9. Accordingly, the CPU 11 (the second grouping processing unit 84) of the mobile terminal 8 makes a request to the electronic receipt management server 9 to obtain electronic receipts (merchandise sales data) belonging to the group of the designated group code.

On the other hand, the CPU 51 (the first grouping means) of the electronic receipt management server 9, when receiving a selection of a group code from the mobile terminal 8, reads electronic receipt information (merchandise sales data) belonging to the designated group code among the electronic receipt information correlated with the membership code of the mobile terminal 8, from the storage unit 53. Then, the CPU (the electronic receipt transmission unit 57) of the electronic receipt management server 9 transmits the electronic receipt information (merchandise sales data) read from the storage unit 53 to the mobile terminal 8.

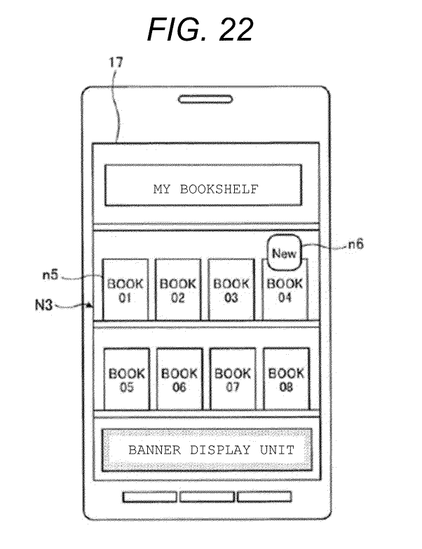

The CPU 11 (the electronic receipt display unit 83) of the mobile terminal 8 displays the electronic receipt information (merchandise sales data) transmitted from the electronic receipt management server 9 on the display unit 17 like the display example N3 illustrated in FIG. 22. In FIG. 22, an example in which my bookshelf n2 of FIG. 21 is designated is illustrated, and a list of books n5 (merchandise sales data) which are purchased so far is arranged in a bookshelf shape to be displayed. Here, information of an image and the like of the books n5 may be included in electronic receipt information and merchandise sales data, and may be obtained from an external web server based on information which may uniquely specify merchandise such as book's library of congress classification code or International Standard Book Number (ISBN) included in the merchandise sales data.

The saving location of the grouping information is not limited to the electronic receipt management server 9, but the grouping information may be saved in a portable device such as a consumer's own device (the mobile terminal 8). In addition, the saving location of the grouping processing program P12a is not limited to the mobile terminal 8, but the program may be saved in the electronic receipt management server 9. Moreover, in this case, the CPU 51 of the electronic receipt management server 9 may execute the grouping processing program P12a according to a request from the mobile terminal 8 to provide a function of the grouping processing described above to the mobile terminal 8 across the network.

Therefore, by grouping electronic receipt information or merchandise included in the electronic receipt information into the same group according to an instruction from a user, it is possible to easily confirm the history of the purchased merchandise, thereby increasing the effective use of the electronic receipt and improving the convenience of a user. For example, when grouping “my bookshelf” and “my medicine chest” described above, it is possible to easily confirm purchased books and medicines, so that it is possible to prevent purchasing in duplicate as well as confirm a need to purchase an item, or to support the decision to purchase an additional item of the same kind, and the like.

In addition, on a company side, based on the electronic receipt information (merchandise sales data) included in the grouping information, relevant information associated with the electronic receipt information is generated for provision to the mobile terminal 8, and thereby it is possible to provide promotional services or the like according to each user. For example, when “my bookshelf” described above is grouped, based on merchandise (books) included in the grouped electronic receipt information, it is possible to provide advertising information n6 and the like which advertises a new book to the mobile terminal 8 as relevant information as in the display example N3 illustrated in FIG. 22. The book to be advertised, without particular limitation, may be, for example, a sequel of the book included in the electronic receipt information or may also be a book derived from the trend of the books which have been purchased so far.

In addition, when grouping “my refrigerator” described above, based on merchandise (food) included in the grouped electronic receipt information, it is possible to provide a recipe which uses the food to the mobile terminal 8 as relevant information. In addition, when grouping “my room” described above, based on merchandise (furniture) included in the grouped electronic receipt information, it is possible to provide the layout of the room in which the furniture is used, and contact information when the furniture has a problem (for example, an URL of a shop where you may purchase a screw and the like) and the like to the mobile terminal 8 as relevant information. Moreover, when grouping the above-mentioned “my closet”, based on merchandise (clothing) included in the grouped electronic receipt information, it is possible to provide information on additional items to coordinate, or suggestions on how to coordinate the wardrobe, using the clothing information sent to the mobile terminal 8 as relevant information. In addition, a stylist performing the coordination also may be selectable, and thus it is possible to provide coordination according to a user's preference. In addition, when grouping the above-mentioned “my food”, based on merchandise (food or cooking) in the grouped electronic receipt information, it is possible to provide relevant information regarding health, such as whether the consumer is consuming too much salt, to the mobile terminal 8. The relevant information may be stored and managed by the electronic receipt management server 9 in correlation with the electronic receipt information (merchandise sales data). In this case, the CPU 51 (the electronic receipt transmission unit 57) of the electronic receipt management server 9 transmits the electronic receipt information (merchandise sales data) and the corresponding relevant information to the mobile terminal 8.

The CPU 11 of the mobile terminal 8, when receiving relevant information through the network interface 14, cooperates with the electronic receipt reading program P12 or the grouping processing program P12a, thereby displaying various types of contents provided as the relevant information on the display unit 17. A device which provides the relevant information to the mobile terminal 8 is not limited to the electronic receipt server 6 or the electronic receipt management server 9, but may be other devices not illustrated.

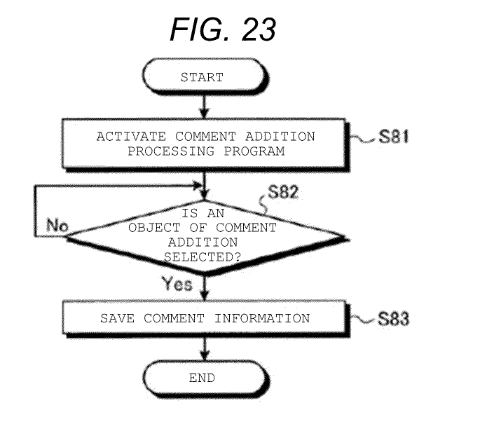

Next, the flow of comment addition processing which is executed by the operation of the CPU 11 of the mobile terminal 8 according to the comment addition processing program P12b will be described referring to the flow chart illustrated in FIG. 23. The processing is executed as a portion of the above-mentioned electronic receipt reading processing. In addition, as a premise of the processing, electronic receipt information as illustrated in FIG. 16 is displayed on the display unit 17.

As illustrated in FIG. 23, when the comment addition processing program P12b is activated (step S81), the CPU 11 of the mobile terminal 8 (the comment addition processing unit 85) waits until the electronic receipt information which is an object of comment addition is selected (No in step S82). The CPU 11 of the mobile terminal 8 (the comment addition processing unit 85), when receiving a selection of the electronic receipt information which is an object of comment addition (Yes in step S82), associates comment information input from a user with the selected electronic receipt information to be saved (step S83).

Here, the comment information is not limited to text information, but may be image data such as photos or illustrations, voice data, and moving image data. The comments that are added are associated with corresponding electronic receipt information to be displayed. In addition, in a case of the voice data or moving image data, for example, reproduction may be initiated according to the selection of the electronic receipt information.

An object of comment addition is not limited to entire electronic receipt information, but may be performed on the basis of merchandise included in the electronic receipt information. For example, like the display example Z illustrated in FIG. 17, specific merchandise may be selected as an object of comment addition from a screen on which merchandise (merchandise a) included in the electronic receipt information is displayed.

Moreover, the save location of comment information is not limited to the user's device (mobile terminal 8), and the electronic receipt information merchandise code may be an object of comment addition and the comments may be transmitted to and saved at the electronic receipt management server 9. Moreover, comments may be saved (transmitted) in services provided by an external device such as a Social Networking Service (SNS). In this case, both the electronic receipt information (merchandise name) which is an object of comment addition and comment information may be transmitted, for example, an URL where the electronic receipt information may be referred to or an URL related to merchandise may be transmitted with the comment information.

In addition, among other users operating an information processing device such as the mobile terminal 8, the comment information may be shared. In this case, for example, one or more other users are grouped in advance, and the comment information may be shared among the grouped members. The grouping of a user is performed using user identification information such as the membership code and the email address of a user, and a telephone number of the mobile terminal 8 which the user has.

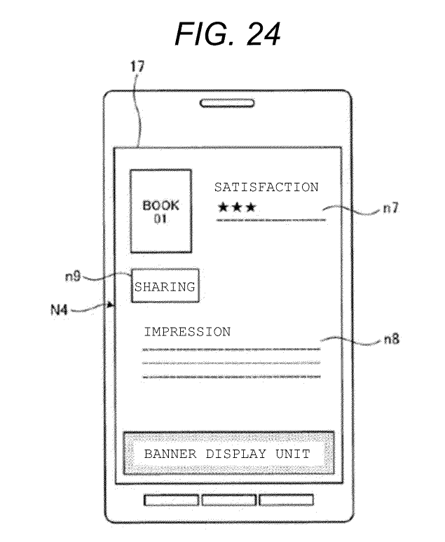

When performing the above-mentioned comment addition, the CPU 11 (comment addition processing unit 85) of the mobile terminal 8, for example, may provide a user with a user interface as illustrated in FIGS. 24 to 26. FIGS. 24 to 26 are front views which show a display example on the display unit 17 of the mobile terminal 8.

Among merchandise included in the electronic receipt information, when merchandise which is an object of comment addition is selected, the CPU 11 of the mobile terminal 8 (comment addition processing unit 85) displays a comment input screen of the merchandise which are the object like the display example N4 in FIG. 24. Here, a screen where a comment about a book is input is displayed in FIG. 24 and, for example, is displayed according to the selection of a book which is an object of comment addition from a book group displayed in FIG. 22. The comment input screen includes a comment column to input satisfaction n7 and impressions n8 and the like about the merchandise (book), and information input to the comment column is saved as comment information.

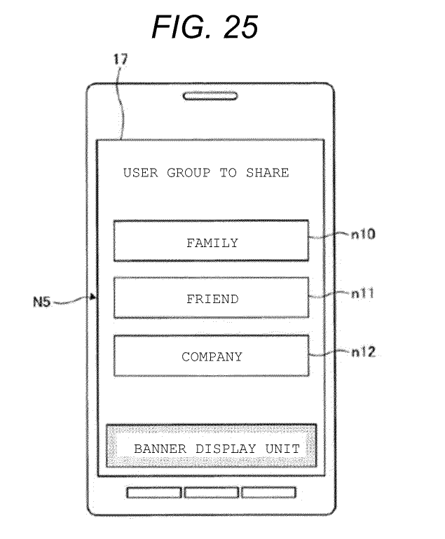

Moreover, as illustrated in FIG. 24, the comment input screen includes a button n9 for instructing a sharing of comments. The CPU 11 of the mobile terminal 8 (comment addition processing unit 85), when receiving the operation of the button n9, displays a selection screen for selecting a user group to share the comments with like the display example N5 illustrated in FIG. 25. In FIG. 25, as a user group to be shares with, a family n10, friends n11, and a company n12 are displayed. In each user group, one or more users are registered in advance.

In the selection screen of FIG. 25, each user group of the family n10, the friends n11 and the company n12 are configured to be selectable. The CPU 11 of the mobile terminal (comment addition processing unit 85), when receiving a selection of any one user group, transmits user identification information of each user belonging to the user group, comment information, and merchandise identification information of merchandise corresponding to the comment information is given, along with a membership code, to the electronic receipt management server 9.

The CPU 51 of the electronic receipt management server 9 stores comment information in association with merchandise specified by merchandise identification information among electronic receipt information specified by the membership code. In addition, the CPU 51 of the electronic receipt management server 9 sets a scope of disclosure so that each user specified by the user identification information (group user) may read the stored comment information. Then, the CPU 51 of the electronic receipt management server 9 notifies the mobile terminal 8 of a group user that comment information has been posted. Here, information which is notified to the mobile terminal 8 may include the corresponding comment information, a URL to disclose the corresponding comment information, and the like. As a technology according to the disclosure of comment information, a known technology such as e-mail, a Web, SNS, is used.

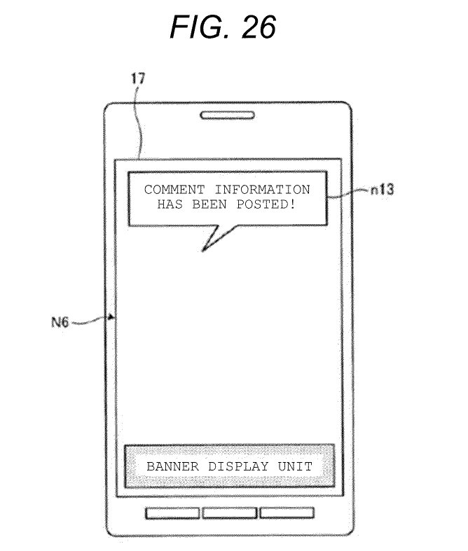

On the other hand, in the mobile terminal 8 of the group user which receives a notification of sharing, the CPU 11 displays a report information n13 which reports there is a posting of comment information like the display example N6 illustrated in FIG. 26. Here, when the report information n13 is selected, the CPU 11 of the mobile terminal 8 (comment addition processing unit 85) obtains corresponding comment information and the like, thereby, for example, displaying the screen of the display example N4 illustrated in FIG. 24 on the display unit 17.

In this manner, by adding comment information to electronic receipt information (merchandise) according to an instruction from a user, an electronic receipt may be used as a memorandum, so that it is possible to increase the effective use of the electronic receipt and to improve the convenience of a user. In addition, when performing a saving (transmitting) on the services like SNS and the like, it is possible to share impressions of the merchandise or service with others or to read the comments of others concerning the merchandise or service. Therefore, it is possible to increase the effective use of an electronic receipt and to improve the convenience of a user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic receipt management server comprising:
an electronic receipt management unit configured to manage a code of each consumer and electronic receipt information in correlation with each other;
a first receiving unit configured to receive from an information processing device of a consumer a selection of electronic receipt information that is an object of grouping, among the electronic receipt information correlated with the code of the consumer; and
a first grouping unit configured to group the selected electronic receipt information into a group to be managed by the electronic receipt management unit.

2. The server according to claim 1, further comprising:
a second receiving unit configured to receive a designation of a group from the information processing device; and
an electronic receipt transmission unit configured to transmit the electronic receipt information belonging to the designated group to the information processing device.

3. The server according to claim 2, wherein
the electronic receipt management unit is configured to manage relevant information related to the electronic receipt information belonging to the designated group and the electronic receipt information in correlation with each other, and
the electronic receipt transmission is configured to transmit both the electronic receipt information belonging to the designated group and the relevant information correlated with the electronic receipt information belonging to the designated group.

4. The server according to claim 1, wherein
the first receiving unit is configured to receive merchandise sales data of the merchandise included in the electronic receipt information, as an object of grouping.

5. The server according to claim 1, further comprising a second grouping unit configured to group information of members who are registered in a common group.

6. The server according to claim 5, wherein the electronic receipt transmission unit is configured to transmit the grouped information to each member of the common group.

7. The server according to claim 5, wherein the electronic receipt transmission unit is configured to transmit grouped information to an internet location accessible by the members of the common group.

8. The server according to claim 5, wherein the grouped information includes at least one comment added by a member of the common group.

9. The server according to claim 1, wherein the first grouping unit is configured to group the electronic sales receipt information into more than one group.

10. An information processing device comprising:
an electronic receipt receiving unit configured to receive electronic receipt information associated with a code of a consumer, from an electronic receipt management server that manages the electronic receipt information according to codes, and to manage electronic receipt information belonging to a group;
an electronic receipt display unit for displaying the electronic receipt information received by the electronic receipt receiving unit; and
a group designation receiving unit configured to receive a designation of the group,
wherein the electronic receipt receiving unit is configured to receive electronic receipt information which corresponds to the code and which belongs to the group.

11. The device according to claim 10, further comprising:
a group object receiving unit configured to receive the electronic receipt information that is an object of grouping, among the electronic receipt information displayed on the electronic receipt display unit; and
a grouping unit configured to group the electronic receipt information according to selections received by the group object receiving unit.

12. The device according to claim 11, wherein
the group object receiving unit is configured to receive merchandise sales data which is included in the electronic receipt information, as an object of grouping, and
the grouping unit is configured to group the merchandise sales data according to selections received by the group object receiving unit.

13. The device according to claim 12, wherein the merchandise sales data includes the identity of purchased goods or services.

14. The device according to claim 10, wherein
the electronic receipt receiving unit is configured to receive the electronic receipt information and additional information related to the electronic receipt information, and
the electronic receipt display unit is configured to display the electronic receipt information and the additional information received by the electronic receipt receiving unit.

15. An information processing method comprising:
managing a code of each consumer, and electronic receipt information in correlation with each other;
receiving electronic receipt information to be grouped among the electronic receipt information correlated with the code of the consumer; and
grouping the electronic receipt information according to selections made among the received electronic receipt information.

16. The information processing method of claim 15, further comprising:
displaying the received electronic receipt information, and
receiving the selections.

17. The information processing method of claim 16, further comprising:
adding the grouped electronic receipt information to a new group by creating the new group and a correlation between the new group and the grouped electronic receipt information.

18. The information processing method of claim 16, further comprising:
adding the grouped electronic receipt information to an existing group by creating a correlation between the existing group and the grouped electronic receipt information.

19. The information processing method of claim 16, wherein the selections are made by the consumer based on purchases for which electronic receipts were issued.

20. The information processing method of claim 16, the wherein the electronic receipt information is grouped into more than one group.
